(19) United States
(12) Patent Application Publication
(10) Pub. No.: US 2016/0191961 A1
(43) Pub. Date: Jun. 30, 2016

(54) FRAGMENTED VIDEO TRANSCODING SYSTEMS AND METHODS

(71) Applicant: IMAGINE COMMUNICATIONS CORP., Frisco, TX (US)

(72) Inventors: Yuval Fisher, Palo Alto, CA (US); Wenfeng Cai, Sunnyvale, CA (US); Neng Gu, Sunnyvale, CA (US); Nam H. Ly, Sunnyvale, CA (US); Shankar Venkataraman, Sunnyvale, CA (US); Pratik Mehta, Sunnyvale, CA (US)

(21) Appl. No.: 14/985,719

(22) Filed: Dec. 31, 2015

Related U.S. Application Data
(60) Provisional application No. 62/098,395, filed on Dec. 31, 2014.

(51) Int. Cl. H04N 21/2343; H04N 21/2662; H04N 21/262; H04N 21/239; H04N 21/231; H04N 21/234

(52) U.S. Cl. CPC H04N 21/234309; H04N 21/23109; H04N 21/23418; H04N 21/26258; H04N 21/2393; H04N 21/2662; H04N 21/26275

(57) ABSTRACT

One example includes a fragmented video transcoding system. The system includes a video fragmenter configured to receive a linear input video data feed and to generate a plurality of video fragment files corresponding to separate portions of the linear input video data feed. The system also includes a transcoder system configured to encode the plurality of video fragment files to generate a plurality of transcoded video fragment files to be accessible for delivery to at least one client device.

### CROSS-REFERENCE TO RELATED APPLICATION

This application claims the benefit of U.S. Provisional Application No. 62/098,395, filed Dec. 31, 2014, and entitled FRAGMENTED-BASED LINEAR TRANSCODING SYSTEMS AND METHODS, which is incorporated herein in its entirety.

### TECHNICAL FIELD

This disclosure relates generally to transcoding video data, and specifically to fragmented video transcoding systems and methods.

### BACKGROUND

The prevalence of streaming video on Internet Protocol (IP) networks has led to the development of Adaptive Bitrate (ABR) (e.g., HTTP-based) streaming protocols for video. There are multiple different instantiations of these protocols. However, ABR streaming protocols typically involve a video stream being broken into short, several-second-long encoded fragment files that are downloaded by a client and played sequentially to form a seamless video view, with the video content fragments being encoded at different bitrates and resolutions (e.g., as “profiles”) to provide several versions of each fragment. Additionally, a manifest file can typically be used to identify the fragments and to provide information to the client as to the various available profiles to enable the client to select which fragments to download based on local conditions (e.g., available download bandwidth). For example, the client may start downloading fragments at low resolution and low bandwidth, and then switch to downloading fragments from higher bandwidth profiles to provide a fast “tune-in” and subsequent better video quality experience to the client.

### SUMMARY

One example includes a fragmented video transcoding system. The system includes a video fragmenter configured to receive a linear input video data feed and to generate a plurality of video input fragment files corresponding to separate portions of the linear input video data feed. The system also includes a transcoder system configured to encode the plurality of video fragment files to generate a plurality of transcoded output video fragment files to be accessible for delivery to at least one client device

Another example includes a method for transcoding a video data stream. The method includes generating a plurality of video fragment files corresponding to separate portions of a received linear input video data feed and storing the plurality of video fragment files in a video fragment storage. The method also includes encoding the plurality of video fragment files via a plurality of transcoders to generate a plurality of transcoded video fragment files and storing the plurality of transcoded video fragment files in a transcoded fragment storage. The method further includes generating a video delivery manifest corresponding to metadata associated with the plurality of transcoded video fragment files via a playlist builder to facilitate video streaming to at least one client device.

Another example includes a video ecosystem. The system includes a fragmented video transcoding system. The fragmented video transcoding system includes a video fragmenter configured to receive a linear input video data feed and to generate a plurality of video fragment files corresponding to separate portions of the linear input video data feed. The fragmented video transcoding system also includes a transcoder system comprising a plurality of transcoders that are configured to concurrently encode a set of the plurality of video fragment files in a time-staggered manner to generate a plurality of transcoded video fragment files sequentially and uninterrupted in real-time. The system further includes a video delivery system configured to provide video streaming of the plurality of transcoded video fragment files to at least one client device in response to a request for video content corresponding to the plurality of transcoded video fragment files.

### BRIEF DESCRIPTION OF THE DRAWINGS

FIG. 1 illustrates an example of a video ecosystem.

FIG. 2 illustrates an example of a fragmented video transcoding system.

FIG. 3 illustrates an example of a transcoder system.

FIG. 4 illustrates an example of a timing diagram demonstrating transcoding of video fragments.

FIG. 5 illustrates another example of a fragmented video transcoding system.

FIG. 6 illustrates yet another example of a fragmented video transcoding system.

FIG. 7 illustrates an example of a method for transcoding video data.

### DETAILED DESCRIPTION

This disclosure relates generally to transcoding video data, and specifically to fragmented video transcoding systems and methods. The fragmented video transcoding can be implemented in a video ecosystem, such as to provide storage and/or delivery of video data to a plurality of client devices, such as via a video streaming service. As used herein, the term video data is intended to encompass video, audio and video, or a combination of audio, video and related metadata. As an example, the fragmented video transcoding system can include one or more video fragmenters configured to receive a linear input video feed and to generate a plurality of video fragment files that correspond to separate chunks of the linear input video data feed. As an example, each input video fragment file can include overlapping portions of adjacent (e.g., preceding and/or subsequent) video fragment files of the input video feed. The fragmented video transcoding system can also include a transcoder system that is configured to encode the plurality of video fragment files into a plurality of transcoded video fragment files that can be stored in a transcoded fragment storage. The transcoded video fragment files thus can be accessible for storage and/or delivery to one or more client device, which delivery can include real time streaming of the transcoded video or storage in an origin server for on-demand retrieval.

In some examples, the transcoder system can include a plurality of transcoders. For instance, the different transcoders can employ different encoding algorithms (e.g., combining spatial and motion compensation) to transcode the video fragment files and provide corresponding transcoded video fragment files in each of the different encoding formats, such as associated with different bitrates and/or resolution. Additionally or alternatively, a plurality of different transcoder subsystems can each include a plurality of transcoders for encoding the video to a respective encoding format (e.g., representing the input video in compressed format). The transcoders in a given transcoder subsystem can be implemented to concurrently encode the video fragment files in a time-staggered, parallel manner to provide the plurality of transcoded video fragment files sequentially and uninterrupted in real-time. Accordingly, each transcoder subsystem can provide transcoded video fragment files in real-time, even if implementing a longer-than-real-time encoding scheme. In addition, the transcoder system can implement a variety of different techniques for aligning audio and video in each of the transcoded video fragment files based on the encoding of the individual video fragment files rather than a linear input video data feed.

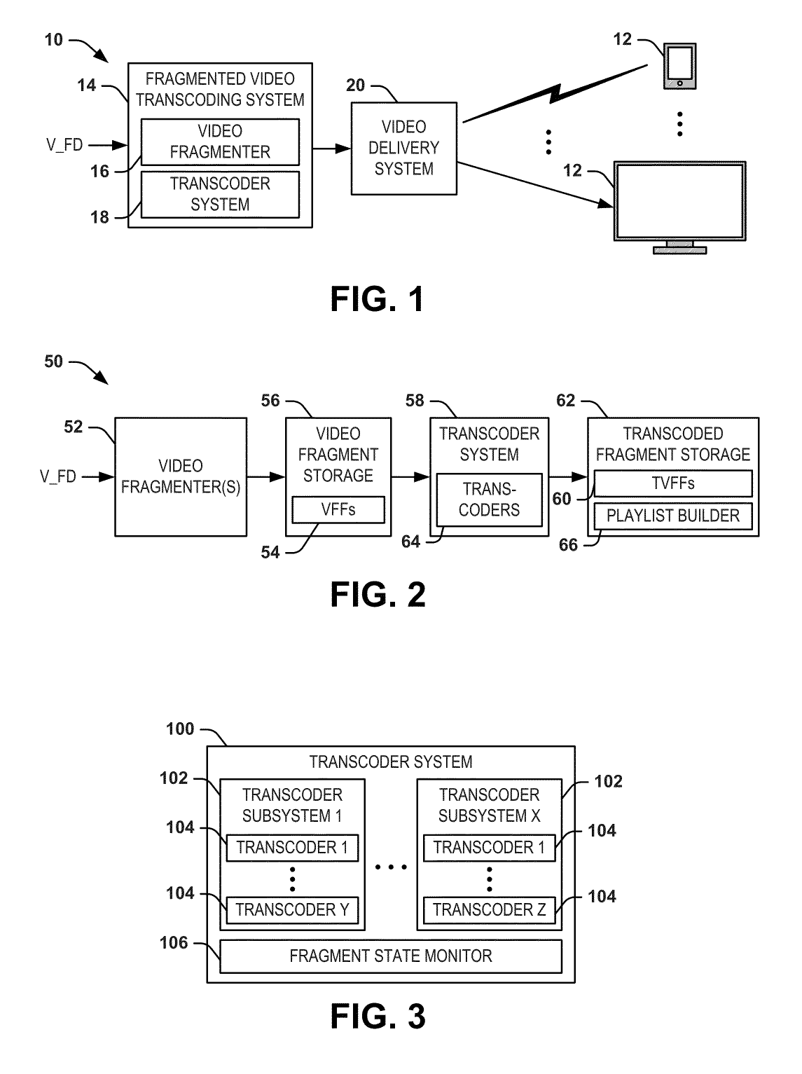

FIG. 1 illustrates an example of a video ecosystem 10. The video ecosystem 10 can be implemented in any of a variety of services to provide and/or enable delivery of video data to a plurality of different types of client devices 12, demonstrated in the example of FIG. 1 as wireless video streaming to a portable electronic device (e.g., a tablet or a smartphone) and/or physically linked streaming to a television (e.g., via a set-top box or to a smart-television). It is to be understood, however, that any of a variety of different types of client devices 12 can be implemented in the video ecosystem 10, and that the video streaming can occur over any of a variety of different types of media. Therefore, the video ecosystem 10 can accommodate multi-screen viewing across multiple different display devices and formats.

The video ecosystem 10 includes a fragmented video transcoding system 14. The fragmented video transcoding system 14 is configured to convert a linear input video data feed, demonstrated in the example of FIG. 1 as “V_FD”, into transcoded video fragment files, as disclosed herein. The fragmented video transcoding system 14 includes a video fragmenter 16 and a transcoder system 18. The video fragmenter 16 is configured to receive the linear input video data feed V_FD in an input format and to generate a plurality of video fragment files that correspond to the linear input video data feed V_FD. The linear input video data feed V_FD can be provided in an input format as uncompressed digital video or in another high resolution format via a corresponding video interface (e.g., HDMI, DVI, SDI or the like).

As used herein, the term “video fragment file” refers to a chunk of media data feed V_FD that is one of a sequence of video chunks that collectively in a prescribed sequence corresponds to the linear input video. For example, the fragmenter can produce each video fragment file to include a fragment (e.g., a multi-second snippet) of video in its original resolution and format. In other examples, the video fragment files can include snippets of video in other formats (e.g., encoded video). The video fragment files can be stored in video fragment storage (e.g., non-transitory machine readable medium) as snippets of the digital baseband video versions (e.g., YUV format) of the linear input video data feed, can be stored as transport stream (TS) files, or can be stored as having a duration that is longer than the resultant video fragments that are provided to the client device(s) 12, as described herein. As an example, each video fragment file can be a data file that includes just video, both video and audio data, or can refer to two separate files corresponding to a video file and an audio file to be synchronized.

The transcoder system 18 is configured to encode (e.g., transcode) the plurality of video fragment files from its original format into corresponding transcoded video fragment files in one or more encoded output video formats. The transcoded video fragment files can be stored in a transcoded fragment storage, such that they are accessible for video streaming to the client device(s) 12 in one or more desired formats. For example, the video delivery system 20 can be implemented an origin server for storing the transcoded video or via a respective video streaming service to deliver streaming media to the clients 12.

As an example, the transcoder system 18 can include a plurality of transcoders, such that different transcoders can be implemented in different transcoder subsystems to employ different encoding protocols to provide the transcoded video fragment files in the different protocols, such as associated with different bitrates and/or resolutions. Thus, the transcoder system 18 can generate multiple different transcoded video fragment files for each video fragment file, with each of the different transcoded video fragment files for a given video fragment file encoded to a different bitrate to accommodate a range of bitrates for use in adaptive bitrate (ABR) streaming. Additionally or alternatively, each of the different transcoded video fragment files for a given video fragment file can be encoded to a different video encoding format packaged in a container for streaming (e.g., HTTP Live Streaming (HLS), HTTP adaptive streaming (HAS), Adobe Systems HTTP dynamic streaming, Microsoft smooth streaming, MPEG dynamic adaptive streaming over HTTP (DASH) or other ABR protocols) and at multiple bitrates to accommodate different ABR technologies.

As another example, each of transcoder subsystems of the transcoder system 18 can include multiple transcoders that are implemented to concurrently encode the video fragment files in a time-staggered manner in parallel to provide the plurality of transcoded video fragment files sequentially and uninterrupted in real-time. In this approach, the video ecosystem 10 can provide video streaming of the transcoded video fragment files in real-time, even with a longer-than-real-time encoding scheme of the transcoder system 18.

The transcoded video fragment files can thus be stored in memory for subsequent delivery (e.g., in an origin server) or be delivered more immediately to the client devices 12 via a video delivery system 20. As described herein, the term “video delivery” and “delivery” with respect to video data refers to any of a variety of manners of providing video data to one or more client devices (e.g., one or more of the client devices 12), such as including broadcast, multicast, unicast, video streaming, or any other way to transmit video data. As an example, the video delivery system 20 can access the transcoded video fragment files from a storage device, such as in response to a request for video content from one of the client devices 12, and can provide the transcoded video fragment files as the requested video content to the respective client device(s) 12. For example, the video delivery system 20 can be configured as or can include an HTTP server, such as to provide linear or on-demand delivery of the transcoded video fragment files. As another example, the video delivery system 20 can be configured as or can include a TS streaming engine to assemble the transcoded video fragment files and broadcast the transcoded video fragment files as a data stream to the client devices 12, such as based on any of a variety of Internet Protocol (IP) broadcast techniques.

Therefore, the video ecosystem 10 can provide video delivery in both linear and nDVR ecosystems of the linear input video data feed V_FD, in either ABR or fixed bitrate streaming protocols. The video ecosystem accomplishes this by fragmenting the linear input video data feed V_FD prior to encoding the video data via the transcoder system 18. As a result of fragmenting prior to encoding, the video ecosystem 10 can implement longer-than-real-time transcoders in a linear environment, such as to provide high computation and/or high-video quality (e.g., multi-pass or high-complexity high-efficiency video coding (HEVC)). The fragmentation of the linear input video data feed V_FD prior to the encoding also allows a more simple ABR packaging methodology based on the transcoder system 18 encoding the video fragment files, as opposed to the linear input video data feed V_FD itself. Additionally, by implementing a large number of transcoders in the transcoder subsystems of the transcoder system 18, the video ecosystem 10 can allow for an unlimited number of instantaneous decoder refresh (IDR) aligned video fragments without requiring any communication between transcoders, which facilitates aligning transcoded fragments downstream. Furthermore, the file-to-file transcoding of (e.g., from fragmented files to transcoded files) is more error resilient and mitigates potential failures. This can result in increased video quality at playout. The flexible arrangement of the transcoders in the transcoder system 18 can also enable the addition of new codecs (e.g., HEVC) through the introduction of different encoders into the transcoder system 18 without having to alter input or output interfaces.

FIG. 2 illustrates an example of a fragmented video transcoding system 50. The fragmented video transcoding system 50 can correspond to the fragmented video transcoding system 14 in the example of FIG. 1. Therefore, reference can be made to the example of FIG. 1 in the following description of the example of FIG. 2 for additional context of how it may be used and in a video ecosystem. The components in the fragmented video transcoding system 50 can be implemented as hardware, software (e.g., machine-readable instructions executable by a processor) or a combination of hardware and software.

The fragmented video transcoding system 50 includes one or more video fragmenters 52 that are each configured to receive the linear input video data feed V_FD. As mentioned, the linear input video data feed V_FD can be uncompressed video or be in another video format (e.g., MPEG-2, H.264 H.265 or the like). The video fragmenter(s) 52 are configured to generate a plurality of video fragment files, demonstrated in the example of FIG. 2 as “VFFs” 54, that are stored in a video fragment storage 56. The video fragment storage 56 can be implemented as a file storage device or system, which can be co-located with the video fragmenter(s) 52 (e.g., in a server or other video processing appliance). The VFFs 54 thus correspond to chunks of the linear input video data feed V_FD. As an example, the video fragmenter(s) 52 can include multiple video fragmenters 52 that are configured to generate the VFFs 54 from a single linear input video data feed V_FD, such that the VFFs 54 are generated redundantly, such as to mitigate service outages in the event of a failure of one or more of the video fragmenters 52. As another example, separate portions of a single input video data feed V_FD can be generated by separate respective ones of the multiple video fragmenters 52 to provide the VFFs 54 for greater efficiency. As yet another example, the multiple video fragmenters 52 can be configured to each process separate respective input video data feeds V_FDs, or can be arranged in a combination with the previous examples to provide redundant processing or separate portion processing of multiple input video data feeds V_FDs to generate the VFFs 54.

The VFFs 54 stored in the video fragment storage 56 can each be arranged as files of video fragments and corresponding audio fragments having a duration of one or more seconds of time (e.g., less than one minute, such as about 3-5 seconds). The VFFs 54 can correspond to any of a variety of different formats of video fragment files. For example, the VFFs 54 can be stored as baseband versions (e.g., YUV format) of the linear input video data feed V_FD. As an example, additional metadata, such as audio and data Program Identification files (PIDs) can also be stored using an encapsulation format to preserve timing relationships between the video and audio portions of the VFFs 54. As another example, the VFFs 54 can be stored as TS files, such as to allow audio and other PID data to be stored in the same file with associated synchronization information. Alternatively, if the linear input video data feed V_FD is provided in an MPEG-2 or H.264 format, for example, each of the VFFs can be generated as having a closed Group of Pictures (GOP) data structure that begins with an I-frame.

Additionally or alternatively, each VFFs 54 can be generated to include overlapping portions of media that are redundant with a portion of adjacent fragments, for example overlapping with its immediately preceding VFFs and its immediately subsequent VFF. Thus, the VFFs 54 can have a duration that is longer than the resultant video fragments that are provided to the client device(s) 12, and the video fragmenter(s) 52 can provide data that specifies the frames of the VFFs 54 are to be transcoded, as described in greater detail herein. To enable use of overlapping VFFs 54 in the transcoder system 50, information is provided with each VFF (e.g., metadata included with the VFF or separately signaled) to specify which frames of a given VFF are to be transcoded in the output.

The fragmented video transcoding system 50 also includes a transcoder system 58 that is configured to encode the VFFs 54 into transcoded video fragment files that correspond to the VFFs 54, demonstrated in the example of FIG. 2 as “TVFFs” 60. The TVFFs 60 are stored in a transcoded fragment storage 62. The transcoded fragment storage 62 which can be a local or remote non-transitory computer-readable medium configured store the TVFFs 60 in one or more desired encoded video formats.

In the example of FIG. 2, the transcoder system 58 includes a plurality of transcoders 64, such as implemented as including different transcoder subsystems. Each transcoder subsystem can be configured to employ a different protocol. For example, the different transcoder subsystems can be configured to implement different encoding protocols for encoding the VFFs 54 to generate multiple different TVFFs 60 for each of the VFFs 54, with each of the transcoder subsystems generate different TVFFs 60 associated with a respective different protocol. Each of TVFFs 60 thus can be encoded to a different output video format. Additionally, for each output video format to which the TVFFs are transcoded, each transcoder subsystem can provide the TVFFs 60 at a plurality of different bitrates and/or resolutions, such as to enable delivery thereof at a desired bitrate according to a desired ABR streaming technology. Each of the TVFFs 60 can include alignment information that is used (e.g., by downstream client 12) to align and playout each of the TVFFs in a continuous stream. In the example of transcoding the TVFFs to H.264 coding standard, the alignment information can be implemented as an instantaneous decoder refresh (IDR) access unit, which can be located at or near the beginning of each TVFF.

As a further example, each of the transcoders 64 can be configured to implement high-quality multi-pass encoding, which can implement a longer-than-real-time encoding scheme. For instance, a set of multiple parallel transcoders 64 in each of transcoder subsystems of the transcoder system 58 can be implemented to concurrently encode the VFFs 54 in a time-staggered manner to output each of the plurality of transcoded video fragment files sequentially and uninterrupted in real-time. Thus, the parallel transcoding provides for streaming of the TVFFs 60 in real-time, even when each of the transcoders implements a longer-than-real-time encoding scheme to generate the TVFFs 60.

The fragmented video transcoding system 50 also includes a playlist builder 66 to generate a manifest that defines properties for the TVFFs in each respective encoded output stream. In the example of FIG. 2, the transcoded fragment storage 62 is demonstrated as including the playlist builder 66. While the example of FIG. 2 demonstrates that the playlist builder 66 is part of the transcoded fragment storage 62, it is to be understood that the playlist builder 66 can be separate from and in communication with the transcoded fragment storage 62. The video delivery manifest can correspond to metadata associated with the TVFFs 60 to enable ABR streaming of the TVFFs 60 (e.g., to the client devices 12) for client-selected media content. For example, the playlist builder 66 can be configured to support multiple transport formats such as Apple HLS, MPEG DASH, Microsoft Smooth Streaming (MSS), Adobe HDS, and any of a variety of video delivery protocols.

By way of further example, the playlist builder 66 is configured to monitor a drop folder (e.g., a specified resource location) associated with the transcoded fragment storage 62 for new TVFFs 60 that are generated by the transcoder system 58 and to automatically create a new video delivery manifest file in response to the storage of the TVFFs 60 in the transcoded fragment storage 62. As an example, the video delivery manifest can include information about the most recently available TVFFs 60, such as including encoding formats, file size, bitrates, resolutions, and/or other metadata related to the TVFFs 60. As another example, the playlist builder 66 can extract the time duration of the TVFFs 60 to include the time duration in the video delivery manifest(s), such as by extracting the time duration data from the transcoder system 58 or by extracting the time duration data directly from the VFFs 54 or the TVFFs 60.

The video delivery manifest(s) can then be provided to a directory (e.g., stored in the transcoded fragment storage 62) that is accessible by the video delivery system 20. Thus, the video delivery system 20 can serve the video delivery manifest(s) to the client devices 12 in response to a request for video content from the respective client devices 12. Accordingly, the video delivery manifest(s) can identify the available TVFFs 60 to the client device 12 to enable the client device 12 to request TVFFs 60 associated with a desired video content at a bitrate and/or resolution that is based on an available bandwidth to provide the appropriate video quality possible according to ABR streaming technology implemented at the client device.

FIG. 3 illustrates an example of a transcoder system 100. The transcoder system 100 can correspond to the transcoder system 18 in the example of FIG. 1 and/or the transcoder system 58 in the example of FIG. 2. Therefore, reference is to be made to the examples of FIGS. 1 and 2 for additional context in the following description of the examples of FIG. 3.

The transcoder system 100 includes a plurality X of transcoder subsystems 102, with X being a positive integer. Each of the transcoder subsystems 102 can correspond to a separate respective encoding protocol that can be implemented to encode the video fragment files (e.g., the VFFs 54) to generate aligned transcoded video fragment files (e.g., the TVFFs 60). Each of the TVFFs can be aligned according to alignment information (e.g., an IDR access unit) that is provided in each TVFF. Each of the transcoder subsystems 102 includes a plurality of transcoders 104, demonstrated as pluralities Y and Z in the example of FIG. 3, with Y and Z each being positive integers. The transcoder subsystems 102 can thus each include a different number Y and Z of transcoders 104 relative to each other.

As an example, each of the transcoder subsystems 102 can be associated with different encoding protocols and be configured to encode the TVFFs to respective bitrates and resolutions. The protocols can include, but are not limited to H.264, MPEG-2, and/or HEVC encoding formats. Thus, each of the transcoder subsystems 102 can generate multiple different transcoded video fragment files corresponding to each of the video fragment files. Each of the transcoded video fragment files generated from a given one of the transcoder subsystems 102 thus can be provided in a different video coding format for the each of the video fragment files. As an example, each of the transcoders 104 can be configured to implement high-quality multi-pass encoding, and can provide multiple transcoded video fragment files for each of the video fragment files that are each encoded at different bitrates and/or resolutions. Thus, the transcoded video fragment files can provide the same or greater level of video quality as other coding formats while having increased compression due to the video encoding technique.

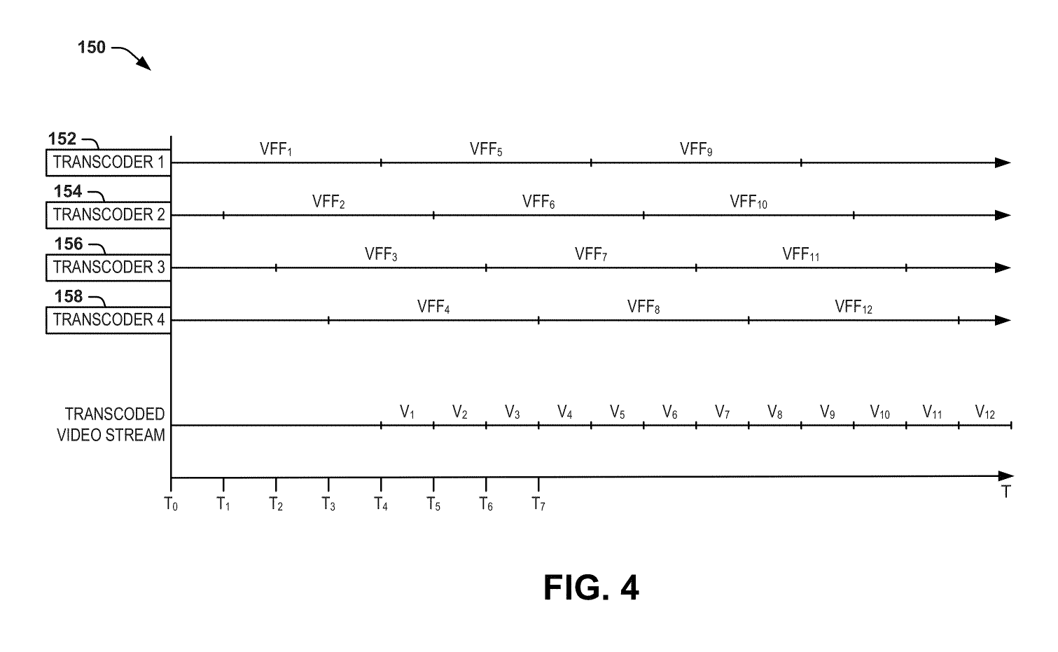

As another example, the plural transcoders 104 in each of transcoder subsystems 102 of the transcoder system 100 can implement longer-than-real-time encoding in a linear encoding environment (e.g., for each video fragment file—VFFs 54) by adding overall latency and transcoding different video fragment files concurrently in parallel in a time-staggered manner. FIG. 4 illustrates an example of a timing diagram 150. The timing diagram 150 in the example of FIG. 4 demonstrates longer-than-real-time transcoding of separate respective groups of video fragment files, demonstrated as input VFFs. As illustrated in the timing diagram 150, the transcoder subsystem includes four transcoders, demonstrated as a first transcoder 152, a second transcoder 154, a third transcoder 156, and a fourth transcoder 158. Other numbers of transcoders could be implemented. The transcoding of the VFFs provides a transcoded video fragment files, demonstrated as “V” in the example of FIG. 4, which can be concatenated as a single output transcoded video stream (“TRANSCODED VIDEO STREAM”). As one example, the encoding of a given one of the VFFs has a time duration that is four times the duration of the video content of the resultant transcoded video fragment file V. As an example, the time duration of the transcoded video fragment files V can correspond to real-time streaming of the associated video content to a client device 12.

By way of further example, at a time T₀, the first transcoder 152 begins to encode a first video fragment file VFF₁. At a time T₁, the second transcoder 154 begins to encode a second video fragment file VFF₂, while the first transcoder 152 continues to encode the first video fragment file VFF₁. At a time T₂, the third transcoder 152 begins to encode a third video fragment file VFF₃, while the first transcoder 152 continues to encode the first video fragment file VFF₁ and the second transcoder 154 continues to encode the second video fragment file VFF₂. At a time T₃, the fourth transcoder 158 begins to encode a fourth video fragment file VFF₄, while the first transcoder 152 continues to encode the first video fragment file VFF₁, the second transcoder 154 continues to encode the second video fragment file VFF₂, and the third transcoder 156 continues to encode the third video fragment file VFF₃.

At a time T₄, the first transcoder 152 finishes encoding the first video fragment file VFF₁, and thus provides a corresponding first transcoded video fragment file V₁. Thus, at the time T₄, the first transcoded video fragment file V₁ can begin being streamed to one or more associated client device 12 that requested the corresponding video content. Also at the time T₄, the first transcoder 152 begins to encode a fifth video fragment file VFF₅, while the second transcoder 154 continues to encode the second video fragment file VFF₂, the third transcoder 156 continues to encode the third video fragment file VFF₃, and the fourth transcoder 158 continues to encode the fourth video fragment file VFF₄.

At a time T₅, the second transcoder 154 finishes encoding the second video fragment file VFF₂, and thus provides a corresponding second transcoded video fragment file V₂. Thus, at the time T₅, the second transcoded video fragment file V₂ can be streamed to the associated client device 12 immediately following the first transcoded video fragment file V₁ in real-time, and thus uninterrupted to the user of the client device 12. Also at the time T₅, the second transcoder 154 begins to encode a sixth video fragment file VFF₆, while the third transcoder 156 continues to encode the third video fragment file VFF₃, the fourth transcoder 158 continues to encode the fourth video fragment file VFF₄, and the first transcoder 152 continues to encode the fifth video fragment file VFF₅.

At a time T₆, the third transcoder 156 finishes encoding the third video fragment file VFF₃, and thus provides a corresponding third transcoded video fragment file V₃. Thus, at the time T₆, the third transcoded video fragment file V₃ can be streamed to the associated client device 12 immediately following the second transcoded video fragment file V₂ in real-time, and thus uninterrupted to the user of the client device 12. Also at the time T₆, the third transcoder 156 begins to encode a seventh video fragment file VFF₇, while the fourth transcoder 158 continues to encode the fourth video fragment file VFF₄, the first transcoder 152 continues to encode the fifth video fragment file VFF₅, and the second transcoder 154 continues to encode the sixth video fragment file VFF₆.

At a time T₇, the fourth transcoder 158 finishes encoding the fourth video fragment file VFF₄, and thus provides a corresponding fourth transcoded video fragment file V₄. Thus, at the time T₇, the fourth transcoded video fragment file V₄ can be streamed to the associated client device 12 immediately following the third transcoded video fragment file V₃ in real-time, and thus uninterrupted to the user of the client device 12. Also at the time T₇, the fourth transcoder 158 begins to encode an eighth video fragment file VFF₈, while the first transcoder 152 continues to encode the fifth video fragment file VFF₅, the second transcoder 154 continues to encode the sixth video fragment file VFF₆, and the third transcoder 156 continues to encode the seventh video fragment file VFF₇.

It is understood that the timing diagram 150 continues therefrom to demonstrate the encoding of additional subsequent video fragment files VFFs into corresponding transcoded video fragment files Vs that immediately follow the preceding transcoded video fragment files Vs in real-time. Accordingly, by fragmenting the linear input video data feed V_FD prior to the transcoder system 100, the transcoder system 100 can concurrently encode a set of the video fragment files VFFs in a time-staggered and segmented manner to provide the corresponding transcoded video fragment files Vs sequentially and uninterrupted in real-time.

The timing diagram 150 of FIG. 4 demonstrates one example in which four separate transcoders 104 generate the sequential transcoded video fragment files in a longer-than-real-time encoding scheme. In the example of FIG. 4, a parallel combination of four transcoders can provide for a real time continuous output stream for the files following the delay associated with the longer-than-real-time transcoding the first transcoded video fragment file VFF1. However, it is to be understood that the number of transcoders 104 that cooperate to provide the sequential transcoded video fragment files can vary. The parallel transcoding of input video fragment files in the transcoder subsystem, such as demonstrated in FIG. 4, can be time-staggered as a function of time that is proportional to the number of transcoders and the encoding time as to provide a continuous output stream. Buffering or other storage of the transcoded video fragment files can also be utilized, as appropriate, to enable real time streaming or storage for subsequent delivery of the video content. As a further example, Table 1 below provides a relationship between the latency of the encoding of the video fragment files, the number of transcoders to provide the encoding, and the transcoding rate:

TABLE 1

| | |
|---|---|
| Segment duration. | Ts |
| Time to transcode a video fragment file | Tt |
| Number of transcoders needed. | >Tt/Ts |
| Overall latency. | N * Ts |

Referring back to the example of FIG. 3, the transcoder system 100 also includes a fragment state monitor 106. The fragment state monitor 106 is configured to monitor a reference frame (e.g, an access unit) of a first of the sequential pair of the video fragment files to determine a reference frame of a second of the sequential pair of the video fragment files to facilitate sequential delivery of the corresponding respective transcoded video fragment files. For example, when encoding audio access units, an audio finite impulse response (FIR) filter used in the encoding may require many samples of audio. Thus, it may be necessary to process audio samples that occurred prior to the audio associated with a currently encoded video fragment file for shorter time duration video fragment files. Therefore, the fragment state monitor 106 is configured to concurrently monitor a preceding fragment file in a sequential pair of the video fragment files to determine the state of the first of the pair in providing the state of the second of the pair with respect to the corresponding access units. The fragment state monitor 106 can be associated with the transcoder system 100, or the transcoder system 100 can include a fragment state monitor 106 for each of the transcoder subsystems 102 or each of the transcoders 104. Accordingly, the transcoded video fragment files that are generated by the transcoder system 100 can have properly aligned (e.g., synchronized) transcoded audio and video fragments, for storage and/or delivery to the client devices 12.

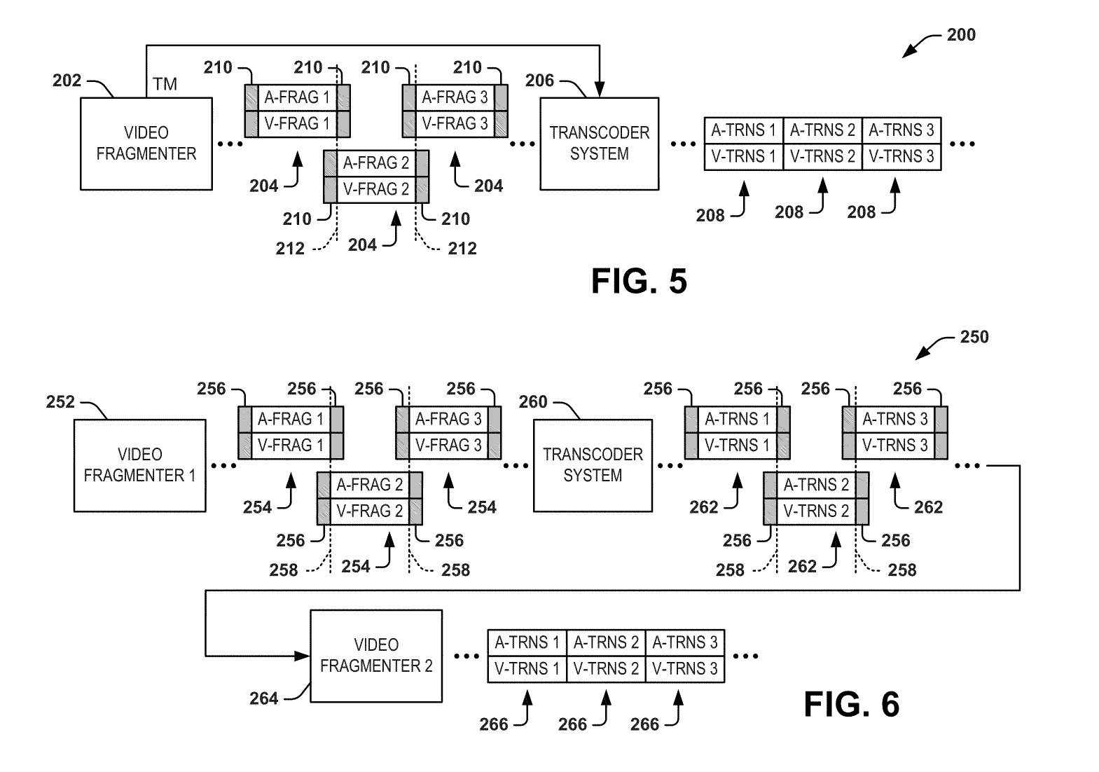

FIG. 5 illustrates another example of a fragmented video transcoding system 200. As an example, the fragmented video transcoding system 200 can provide an alternative to the use of the fragment state monitor 106 in the example of FIG. 3 for the purposes of aligning the audio and video fragments in the transcoded video fragment files. The fragmented video transcoding system 200 can be applicable to the fragmented video transcoding system 14 in the example of FIG. 1, or the fragmented video transcoding system 50 in the example of FIG. 2. Thus, reference can to be made to the examples of FIGS. 1-4 in the following description of the example of FIG. 5.

The fragmented video transcoding system 200 includes a video fragmenter 202 configured to generate video fragment files 204, demonstrated in the example of FIG. 5 as including an audio portion “A-FRAG” and a video portion “V-FRAG”, from a linear input video data feed (e.g., the linear input video data feed V_FD). Similar to as described previously, the video fragment files 204 can be stored in a video fragment storage device and in the same format (e.g., uncompressed or compressed) as the input video data feed V_FD. The fragmented video transcoding system 200 also includes a transcoder system 206 that is configured to encode the video fragment files 204 into transcoded video fragment files 208 that correspond to the video fragment files 204, demonstrated in the example of FIG. 5 as likewise including an audio portion “A-TRNS” and a video portion “V-TRNS”.

In the example of FIG. 5, the video fragmenter 202 is configured to generate the video fragment files 204 to include overlap portions 210 that are redundant with a portion of an immediately preceding one of the video fragment files 204 and an immediately subsequent one of the video fragment files 204, respectively. For example, the overlap portions 210 can include one or more access units or frames arranged at a beginning of and at an end of each of the video fragment files 204. That is, the audio access unit(s) in the overlap portions can overlap the audio portions “A-FRAG” and the frame(s) in the video portions “V-FRAG” of each of the preceding and subsequent video fragment files 204 in the sequence of the linear input video data feed. The overlap of the sequential video fragment files 204 is demonstrated in the example of FIG. 5 by the offset of the video fragment files 204, with dashed lines 212 demonstrating the alignment of the audio portions “A-FRAG” and the video portions “V-FRAG” of each of the preceding and subsequent video fragment files 204 in the sequence of the linear input video data feed. Thus, each of the video fragment files 204 can have a duration that is longer than the resultant transcoded video fragment files 208 that are provided to the client device(s) 12. The alignment at 212 of sequential frames can be indicating by timing (e.g., a time stamp) or other alignment information that is embedded into (e.g., as metadata) or provided separately from each of the respective fragment files 204.

The transcoder system 206 is thus configured to encode the non-overlapping portions of the video fragment files 204 to generate the respective transcoded video fragment files 208. In the example of FIG. 5, the video fragmenter 202 is configured to provide an alignment signal TM to the transcoder system 206 to provide an indication of a location of the overlap portions 210 in each of the video fragment files 204. For example, the alignment signal TM can specify a first time value at which the transcoder is to start transcoding and another time value at which it is to stop transcoding each fragment file. The start and stop time can be provided as an offset time with respect to the beginning of a first fragment file (e.g., from time t=0). Thus, the transcoder system 206 can encode only the frames of the video fragment files 204 that correspond to non-overlapping audio portions “A-FRAG” and the video portions “V-FRAG” of the video fragment files 204. In other examples, the alignment signal TM can employ other means to identify the specific frames of each of the video fragment files 204 that are non-overlapping, and thus to be encoded by the transcoder system 206. Therefore, the transcoded video fragment files 208 can be generated by the transcoder system 206 as being aligned with respect to the audio portion “A-TRNS” and the video portion “V-TRNS”, and can be aligned with respect to each other in the sequence. Accordingly, the fragmented video transcoding system 200 can be arranged to substantially mitigate null padding, audio and/or video gaps between successive transcoded video fragment files 208, audio glitching, and/or video artifacts that can result from misalignment of the successive transcoded video fragment files 208 based on transcoding the video fragment files 204.

FIG. 6 illustrates another example of a fragmented video transcoding system 250. As an example, the fragmented video transcoding system 250 can provide an alternative to the use of the fragment state monitor 106 in the example of FIG. 3 for the purposes of aligning the audio and video fragments in the transcoded video fragment files. The fragmented video transcoding system 250 can be applicable to the fragmented video transcoding system 14 in the example of FIG. 1, or the fragmented video transcoding system 50 in the example of FIG. 2. Thus, reference can to be made to the examples of FIGS. 1-4 in the following description of the example of FIG. 6 for additional context of how it can be implemented in a video delivery system.

In the example of FIG. 6, the fragmented video transcoding system 250 includes a first video fragmenter 252 configured to generate video fragment files 254, demonstrated in the example of FIG. 6 as including an audio portion “A-FRAG” and a video portion “V-FRAG”, from a linear input video data feed (e.g., the linear input video data feed V_FD). Similar to as described previously, the video fragment files 254 can be stored in a video fragment storage. In the example of FIG. 6, the first video fragmenter 252 is configured to generate the video fragment files 254 to include overlap portions 256 that are redundant with a portion of an immediately adjacent (e.g., preceding and subsequent) video fragment files 254. For example, the overlap portions 256 can be arranged at a beginning of and at an end of each of the video fragment files 254, such that the overlap portions can overlap the audio portions “A-FRAG” and the video portions “V-FRAG” of each of the preceding and subsequent video fragment files 254 in the sequence of the linear input video data feed. The overlap of the sequential video fragment files 254 is demonstrated in the example of FIG. 6 by the offset of the video fragment files 254, with dashed lines 258 demonstrating the alignment of the audio portions “A-FRAG” and the video portions “V-FRAG” of each of the preceding and subsequent video fragment files 254 in the sequence of the linear input video data feed.

The fragmented video transcoding system 250 also includes a transcoder system 260 that is configured to encode the video fragment files 254 from an input format (corresponding to the linear input feed) to an output format corresponding to transcoded video fragment files 262 that correspond to the video fragment files 254. As demonstrated in the example of FIG. 6, each of the transcoded fragment files 254 includes an audio portion “A-TRNS” and a video portion “V-TRNS”. In the example of FIG. 6, in contrast to the fragmented video transcoding system 200 in the example of FIG. 5, which only encodes the non-overlapping portions of the respective sequential fragments, the transcoder system 260 is configured to encode the video fragment files 254 to generate the respective transcoded video fragment files 262 that likewise include the overlap portions 256 that are likewise encoded. In the example of FIG. 6, the fragmented video transcoding system 250 also includes a second video fragmenter 264 that is configured to remove the overlap portions 256 from each of the transcoded video fragment files 262. As an example, the first video fragmenter 252 can provide an indication of the specific frames of the video fragment files 254, and thus each of the transcoded video fragment files 262, that are non-overlapping to the second video fragmenter 264. For example, the frames can be specified as an offset time from a start time for the video program. Thus, the second video fragmenter 264 can remove the overlap portions 256 from the transcoded video fragment files 262 to provide aligned transcoded video fragment files 266.

Therefore, similar to as described previously in the example of FIG. 5, the transcoded video fragment files 262 can be provided to the client devices 12 as being aligned with respect to the audio portion “A-TRNS” and the video portion “V-TRNS”, and thus aligned with respect to each other in the sequence. Accordingly, the fragmented video transcoding system 250 can be arranged to substantially mitigate null padding, audio and/or video gaps between successive transcoded video fragment files 262, audio glitching, and/or video artifacts that can result from misalignment of the successive transcoded video fragment files 262 based on transcoding the video fragment files 254.

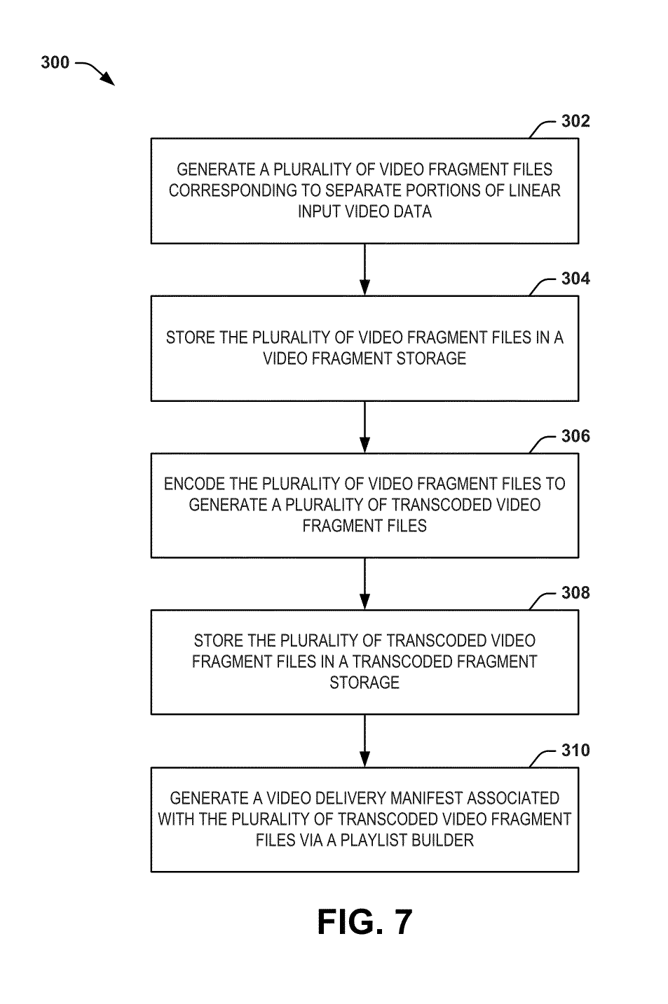

In view of the foregoing structural and functional features described above, a method in accordance with various aspects of the present invention will be better appreciated with reference to FIG. 7. While, for purposes of simplicity of explanation, the method of FIG. 7 is shown and described as executing serially, it is to be understood and appreciated that the method is not limited by the illustrated order, as some aspects could, in other embodiments, occur in different orders and/or concurrently with other aspects from that shown and described herein. Moreover, not all illustrated features may be required to implement a method. Additionally, the method can be implemented in hardware, software (e.g., machine-readable instructions executable by one or more processors) or a combination of hardware and software.

FIG. 7 illustrates an example of a method 300 for transcoding video data. At 302, a plurality of video fragment files (e.g., VFFs 54) corresponding to separate portions of a received linear input video data feed (e.g., linear input video data feed V_FD) is generated. At 304, the plurality of video fragment files are stored in a video fragment storage (e.g., video fragment storage 56). At 306, the plurality of video fragment files are encoded via a plurality of transcoders (e.g., transcoders 64) to generate a plurality of transcoded video fragment files (e.g., TVFFs 60). At 308, the plurality of transcoded video fragment files are stored in a transcoded fragment storage (e.g., the transcoded fragment storage 62). At 310, a video delivery manifest associated with the plurality of transcoded video fragment files is generated via a playlist builder (e.g., playlist builder 66). The manifest file can enable streaming of video content to one or more client devices (e.g., client devices 12).

What have been described above are examples. It is, of course, not possible to describe every conceivable combination of components or methodologies, but one of ordinary skill in the art will recognize that many further combinations and permutations are possible. Accordingly, the disclosure is intended to embrace all such alterations, modifications, and variations that fall within the scope of this application, including the appended claims. As used herein, the term “includes” means includes but not limited to, the term “including” means including but not limited to. The term “based on” means based at least in part on. Additionally, where the disclosure or claims recite “a,” “an,” “a first,” or “another” element, or the equivalent thereof, it should be interpreted to include one or more than one such element, neither requiring nor excluding two or more such elements.

What is claimed is:

1. A video transcoding system comprising:
a video fragmenter configured to receive a linear input video data feed and to generate a plurality of video fragment files corresponding to separate portions of the linear input video data feed; and
a transcoder system configured to encode each of the plurality of video fragment files to generate a plurality of transcoded video fragment files in an encoded output format to be accessible for delivery to at least one client device.

2. The system of claim 1, wherein the transcoder system comprises a plurality of transcoders that are configured to concurrently encode a sequential set of the plurality of video fragment files in a time-staggered manner, each according to a respective encoding format, to provide the plurality of transcoded video fragment files sequentially and uninterrupted in real-time.

3. The system of claim 1, wherein the plurality of video fragment files are stored in a video fragment storage that is accessible by the transcoder system for encoding the plurality of video fragment files.

4. The system of claim 1, wherein the transcoder system comprises a plurality of transcoder sub-systems, each of the plurality of transcoder sub-systems being configured to encode the plurality of video fragment files from an input format of the linear input video data feed to generate a plurality of corresponding transcoded video fragment files in each of a plurality of different output encoding formats.

5. The system of claim 1, wherein the transcoder system comprises at least one transcoder configured to concurrently encode a sequential pair of the plurality of video fragment files, wherein the transcoder system comprises a fragment state monitor configured to monitor a reference frame of a first of the sequential pair of the plurality of video fragment files to determine a state information a second of the sequential pair of the plurality of video fragment files, the transcoder system employing the state information to transcode the second of the sequential pair of the plurality of video fragment files into a corresponding transcoded video fragment file in the encoded output format.

6. The system of claim 1, wherein the video fragmenter is configured to generate each of the plurality of video fragment files to comprise an overlap portion that is redundant with a portion of immediately adjacent video fragment files.

7. The system of claim 6, wherein the transcoder system is configured to identify non-overlapping portions of the plurality of video fragment files based on alignment information specifying start and stop locations of the non-overlapping in each of the plurality of video fragment files, the transcoder system further to generate the plurality of transcoded video fragment files from the identified non-overlapping portions of the plurality of video fragment files.

8. The system of claim 6, wherein the video fragmenter further comprises:
a first video fragmenter configured to receive the linear input video data feed and to generate the plurality of video fragment files that are encoded by the transcoder system to generate the plurality of transcoded video fragment files, each comprising the first overlap portion and the second overlap portion, and
a second video fragmenter that is configured to receive the plurality of transcoded video fragment files and to remove each overlap portion from the plurality of transcoded video fragment files.

9. The system of claim 1, wherein the video fragmenter is a first of a plurality of video fragmenters, wherein each of the plurality of video fragmenters is configured to generate the plurality of video fragment files corresponding to at least one of separate portions of the linear input video data feed and separate portions of a plurality of linear input video data feeds.

10. The system of claim 1, further comprising:
a transcoded fragment storage to store the plurality of transcoded video fragment files; and
a playlist builder configured to continuously generate a video delivery manifest, corresponding to metadata associated with the plurality of transcoded video fragment files, to facilitate delivery of the plurality of transcoded video fragment files to the at least one client device.

11. A video ecosystem comprising the video transcoding system of claim 10, the video ecosystem further comprising a video delivery system configured to provide each of the plurality of transcoded video fragment files to the at least one client device in an adaptive bitrate format responsive to a request for video content corresponding to the plurality of transcoded video fragment files generated by the at least one client based on the video delivery manifest.

12. A method for transcoding video data, the method comprising:
generating a plurality of video fragment files corresponding to separate portions of a received linear input video data feed;
storing each of the plurality of video fragment files in a fragment storage;
encoding the plurality of video fragment files from the video fragment storage via a plurality of transcoders to generate a plurality of transcoded video fragment files;
storing each of the plurality of transcoded video fragment files in a transcoded fragment storage; and
generating a video delivery manifest corresponding to metadata associated with the plurality of transcoded video fragment files to enable video streaming to at least one client device.

13. The method of claim 12, wherein encoding the plurality of video fragment files comprises concurrently encoding a set of the plurality of video fragment files in a time-staggered manner via a plurality of parallel transcoders to provide the plurality of transcoded video fragment files sequentially and uninterrupted in real-time.

14. The method of claim 12, wherein encoding the plurality of video fragment files comprises:
concurrently encoding a sequential pair of the plurality of video fragment files;
monitoring a reference frame of a first of the sequential pair of the plurality of video fragment files to determine state information for a second of the sequential pair of the plurality of video fragment files; and
generating a second of the sequential pair of the plurality of transcoded video fragment files based on the state information determined from the reference frame of the first of the sequential pair of the plurality of video fragment files.

15. The method of claim 12, wherein generating a plurality of video fragment files comprises generating the plurality of video fragment files to comprise a first overlap portion that is redundant with a portion of an immediately preceding one of the plurality of video fragment files and a second overlap portion that is redundant with a portion of an immediately subsequent one of the plurality of video fragment files.

16. The method of claim 15, wherein encoding the plurality of video fragment files comprises:
receiving alignment information specifying a location of the first overlap portion and the second overlap portion in each of the plurality of video fragment files; and
encoding non-overlapping portions of the plurality of video fragment files based on the alignment information to generate the plurality of transcoded video fragment files.

17. The method of claim 15, wherein encoding the plurality of video fragment files comprises encoding the plurality of video fragment files comprising the first and second overlap portions along with the non-overlap portions to generate the plurality of transcoded video fragment files, the method further comprising removing the first overlap portion and the second overlap portion from each of the plurality of transcoded video fragment files.

18. A video delivery system comprising:
a fragmented video transcoding system comprising:
a video fragmenter configured to receive a linear input video data and to generate a plurality of video fragment files corresponding to separate portions of the linear input video data; and
a transcoder system comprising a plurality of transcoders that are configured to concurrently encode a set of the plurality of video fragment files in a time-staggered manner to generate a plurality of transcoded video fragment files sequentially and uninterrupted in real-time in at least one encoded output format; and
a video delivery system configured to stream the plurality of transcoded video fragment files to at least one client device in response to a request for video content corresponding to the plurality of transcoded video fragment files.

19. The system of claim 18, wherein the video fragmenter is configured to generate each of the plurality of video fragment files to comprise a first overlap portion that is redundant with a portion of an immediately preceding one of the plurality of video fragment files and a second overlap portion that is redundant with a portion of an immediately subsequent one of the plurality of video fragment files.

20. The system of claim 18, wherein the transcoder system comprises a fragment state monitor configured to use state information of a preceding one of a sequential pair of the plurality of video fragment files to determine state information of a second of the sequential pair of the plurality of video fragment files to facilitate sequential video streaming of the corresponding respective transcoded video fragment files.
